(19) United States
(12) Patent Application Publication
(10) Pub. No.: US 2014/0101741 A1
(43) Pub. Date: Apr. 10, 2014

(54) METHOD AND SYSTEM FOR MOBILE DEVICE BASED AUTHENTICATIONSERVICES ENVIRONMENT

(71) Applicant: Jean Luc Senac, Sao Paulo (BR)

(72) Inventor: Jean Luc Senac, Sao Paulo (BR)

(21) Appl. No.: 13/865,009

(22) Filed: Apr. 17, 2013

Related U.S. Application Data
(63) Continuation of application No. 13/200,183, filed on Sep. 19, 2011, now abandoned.
(60) Provisional application No. 61/458,079, filed on Nov. 16, 2010.

(51) Int. Cl. H04L 29/06

(52) U.S. Cl. CPC H04L 63/0853; H04L 63/083
USPC 726/7

(57) ABSTRACT

In this specification, access may be provided to secure systems by authentication using mobile devices. Users may register a mobile device and password with an authentication system. To access a secure system, users may send a request with a registered phone number via SMS, internet or phone. In an embodiment, the authentication server system may send the token and the position of the password via SMS. Users may enter the authentication code comprising of the token and the password at the secure system. The secure system compares the authentication code with the stored authentication code to grant access to the secure system. Secure access may be used in credit card, pre-paid card, debit card or any other card transactions other financial transactions authentication, login authentication for a computer system and security access authentication.

### CROSS REFERENCE TO RELATED APPLICATIONS

This application is a continuation of U.S. patent application Ser. No. 13/200,183 (Docket No. AI-3), entitled METHOD AND SYSTEM FOR MOBILE DEVICE BASED AUTHENTICATION, by Jean Luc Senac, filed Sep. 19, 2011; which claims priority benefit of U.S. Provisional Patent Application No. 61/458,079 (Docket No. AI-1), entitled METHOD AND SYSTEM FOR MOBILE DEVICE BASED AUTHENTICATION, by Jean Luc Senac, filed Nov. 16, 2010, the contents of which are incorporated herein by reference.

### FIELD OF INVENTION

This specification generally relates to digital security.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In order to access online services such as financial institutions or online merchants, a user must pass through some form of authentication process to verify that the user is who the user claims to be. The authentication process might be as simple and as weak as providing a valid email address or as complicated and robust as receiving a phone call from the merchant or financial institution and verifying personal information over the phone. Phishing is a real problem for one-factor authentications such as credit card payments. Phishing causes significant financial losses to merchants and banks, and as a result of phishing hundreds of million dollars are lost every year.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 shows a diagram of an embodiment of an authentication system;

FIGS. 2A and 2B show an example of an authentication code using the two-factor authentication system;

FIG. 3A shows a flowchart of an embodiment of a two-factor method of authentication from an authentication server system;

FIG. 3B shows a flowchart of an embodiment of a method of generating the two-factor authentication code by the authentication server system.

FIG. 3C shows a diagram of an embodiment of a method comparing codes;

FIG. 4 shows a diagram of an embodiment of a method of authentication from a user device;

FIG. 5 shows a flowchart of an embodiment of a two-step method of authentication using mobile devices;

FIG. 6 shows a flowchart of an embodiment of a three-step method of authentication using mobile devices;

FIG. 7 shows a flowchart of an embodiment of a method for online purchasing with a credit card using the two-factor authentication method;

FIG. 8A shows a screenshot of an example of a web page that may be used in an embodiment requesting an authentication code;

FIG. 8B shows a screenshot of an embodiment of a web page for entering a password;

FIG. 8C shows a screenshot of an embodiment of a web page for choosing the account and method of payment;

FIG. 8D shows a screenshot of an embodiment of a webpage where the purchasing system contacts the bank for authorization;

FIG. 8E shows a screenshot of an embodiment of a user device displaying the token or part of the authentication code;

FIG. 8F shows a screenshot of an embodiment of a keypad for entering the authentication code;

FIG. 8G shows a screenshot of an embodiment of a web page after checking for the authentication code.

FIG. 9A shows a screenshot of an embodiment of a purchasing system entering an email address and password of the merchant;

FIG. 9B shows a screenshot of an embodiment of a purchasing system entering a phone number;

FIG. 9C shows a screenshot of an embodiment of a purchasing system confirming a customer's information;

FIG. 9D shows a screenshot of an embodiment of a purchasing system confirming a customer's information;

FIG. 9E shows a screenshot of an embodiment of a secure system or bank requesting an authentication code;

FIG. 9F shows a screenshot of an embodiment of a secure system 101 or bank displaying a successful authentication of code;

FIG. 10 shows a screenshot of an embodiment of a user generated code;

FIG. 11 shows an embodiment of a user device.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

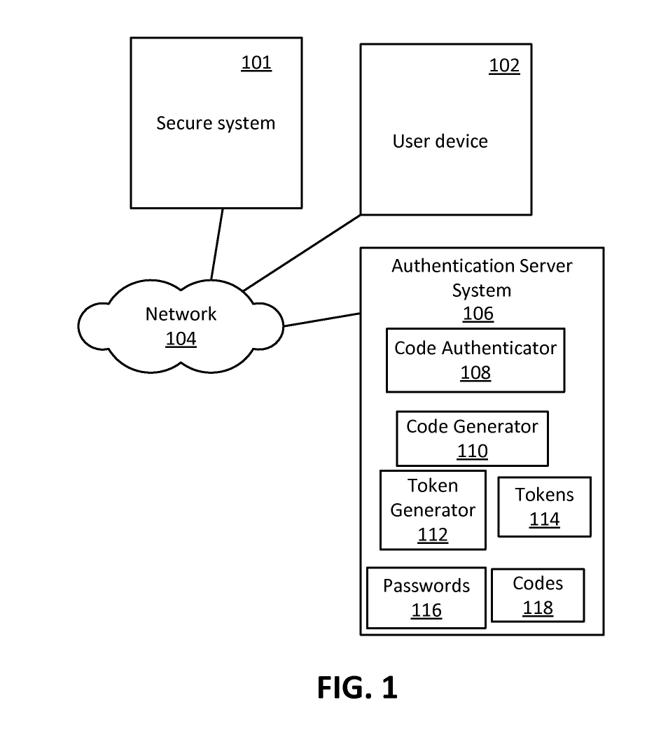

FIG. 1 shows a diagram of an embodiment of system 100 for authentication of mobile device based users. In an embodiment, system 100 may include secure system 101, user device 102, network 104, authentication server system 106, code authenticator 108, code generator 110, token generator 112, tokens 114, passwords 116, and codes 118. In other embodiments host system 100 may not have all of the elements or features listed and/or may have other elements or features instead of or in addition to those listed.

In an embodiment, secure system 101 may include one or more devices or systems that require authentication in order to gain access. For example secure system 101 may be a bank, a financial institution, a retailer, or any other place that may require secure transactions. Some typical applications requiring secure access may include credit card transactions, pre-paid card transactions, debit card transaction or any other type of transaction, domestic and international fund transfers authentication, any other payment system authentication, financial transactions authentication, login authentication for a system, security access authentication, personal coupons or voucher authentication, restaurant or supermarket tickets, gift cards.

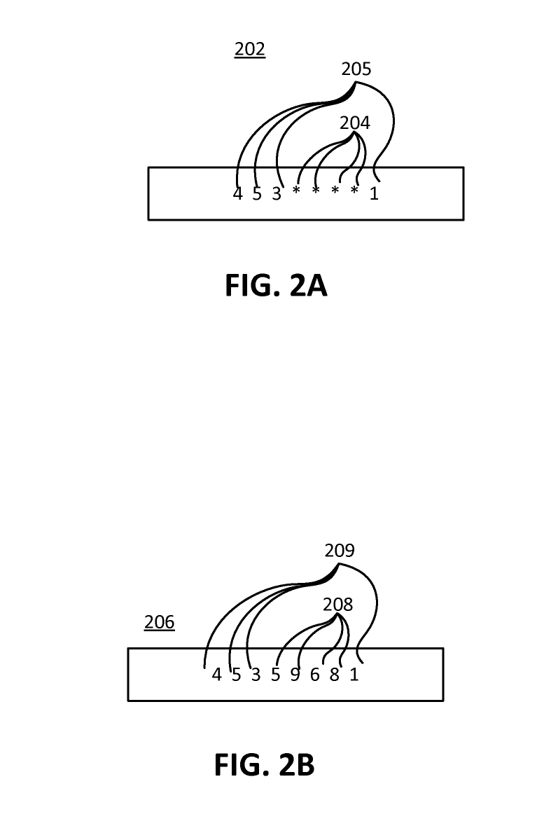

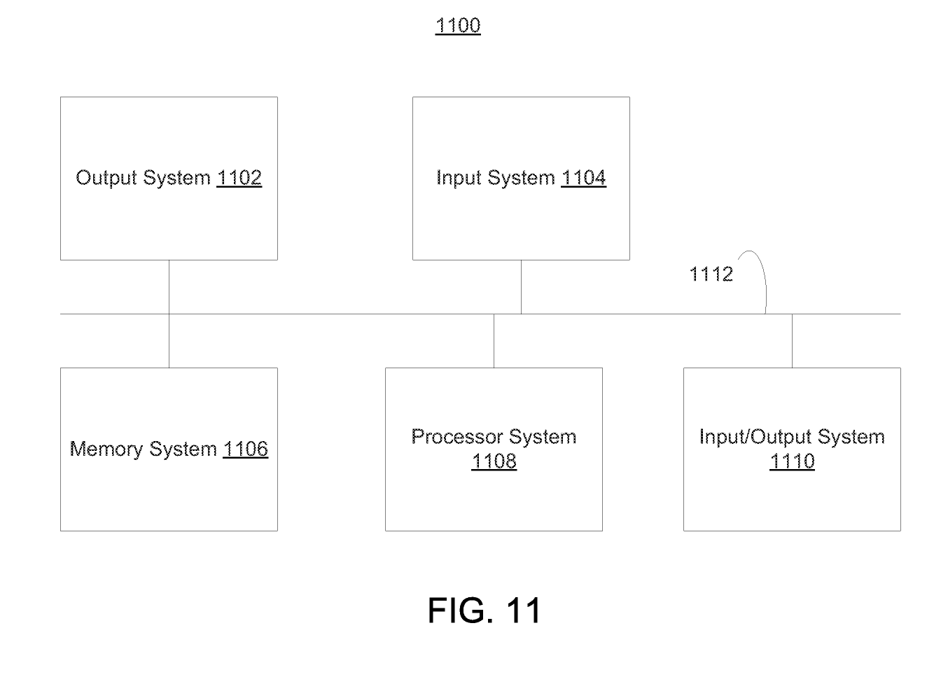

In an embodiment, a phone number of a user device and a password may be registered with an authentication server system. In this specification, cellular phone and mobile phone may be used interchangeably herein and may be examples of user devices. In an embodiment, along with the user device number, user data may be provided. The phone number of user device 102 may be registered with the authentication server system using a computer, laptop, phone, iPad or any other device connected on the internet or to any other communication protocol (which may include one or more servers) that enables the user to send data. The phone number and the password may be registered using a keyboard, virtual keyboard or any other input method suitable for data entry. Network 104 (further discussed in conjunction with FIG. 11) may be any network or combination of networks of devices that communicate with one another, such as any combination of Wide Area Networks (WANs) (e.g., the Internet), Local Area Networks (LANs), Plain Old Telephone System (POTSs), and/or mobile device communications network. Network 104 may be send data to register user device 102. Authentication server system 106 may generate authentication code and may authenticate code via network 104. Authentication server system 106 may require user device 102 to register with authentication server system 106 before user device 102 requests authentication from authentication server system 106. Input data for authentication may be sent using network 104 with any cryptography technology. Authentication server system 106 may be used for authorizing or granting privileges for certain type of actions. Code authenticator 108 is a set of machine instructions for authenticating a code and determining whether the code submitted is valid. Code generator 110 generates a code from the combination of a token and password. Token generator 112 is an algorithm for generating a token. Tokens 114 are the tokens generated by token generator 112, which are being stored for the short period of time for which the token is valid, which may only be a few seconds or a few days or until the token is used once, for example. Tokens 114 are stored on authentication server system 106 long enough so that when a user uses the toke not gain access, the token may be authenticated. Password 116 may be user supplied and are stored at the authentication server system 106 so that the authentication server system 106 may compare a password that is stored to a password received for authenticating a user. Codes 118 are codes generated by code generator 110, which are a combination of a password and a token. Codes 118 are also stored for the purpose of authenticating a user for as long as codes 118 are valid, which is the same period of time for which tokens 116 are valid. Optionally, instead of storing both codes 118 and tokens 114, just codes 118 are stored. Alternatively, the authentication system 106 may store token 114 and the positions of the passwords 116 within codes 118 (the position of the password within token 114 will be discussed in conjunction with FIGS. 2A and 2B). In an embodiment, authentication server system 106 may be part of secure system 102. Alternatively, instead of having code authenticator 108, code generator 110, token generator 112, tokens 114, passwords 116, and codes 118 all located at authentication system 106, all of or any combination of code authenticator 108, code generator 110, token generator 112, tokens 114, passwords 116, and codes 118 may located at secure system 101. In another embodiment, passwords 116 may be stored on a system other than authentication server system 106 or secure system 101.

In an embodiment, to avoid identity theft, the phone number and the password may be registered in authorized locations, such as financial institutions, online merchants, offices or any other secure location. In an embodiment, the registration may be confirmed by sending a message via Short Message System (SMS), email, or a phone call from the authentication server system 106. In an embodiment, in some applications that require increased security, authentication server system 106 may not store the password. A storage unit in a different server belonging to the same organization or to another organization may be used to store the password.

### Authentication Code Generation Rules

FIGS. 2A and 2B show an example of an authentication code using the two-factor authentication method. FIG. 2A shows authentication code 202 and has password position 204 and token 205. Completed authentication code 206 is shown in FIG. 2B, which has password 208 and token 209. In other embodiments example authentication code may not have all of the elements or features listed and/or may have other elements or features instead of or in addition to those listed.

In an embodiment, the authentication codes are generated based upon a set of defined rules. In two-factor authentication system, the code may consist of a token and a password. The token may be generated by the authentication server system; the token may change for every transaction. The token may consist of one or more numbers, letters, symbols or signs. In an embodiment, the length of the token may vary for each authentication code. The password may be a password used while registering user device 102. In an embodiment, an example authentication code 202 may be sent from authentication server system 106 to user device 102 via network 104. Password 204 indicates the position where the password has to be inserted replacing the asterisks. In an embodiment the number of asterisks may not necessarily indicate the length of the password. In another embodiment, the number of asterisks may indicate the number of characters in the user password. In an example, the password starts at position 4. A password may be composed of numbers, letters, symbols or signs. Authentication code 206 has token 209 and completed password 208, in an example the password is completed with 5968, Authentication 206 may be used for authentication to gain access to secure system 101.

In an embodiment, the position of the password in the sequence may be variable, and determined, for example by a random number generator. In another embodiment, the position of the password may be fixed. In other embodiments, depending on the application, the authorization code may be valid for a predetermined fixed number of times. In another embodiment, the authorization code may be valid for only a one time use. In other embodiments, the length of the password may vary each time it is reset. In an embodiment the length of the token may vary with each use. In another embodiment, the authentication code may be valid for a predetermined fixed period of time, for example 24 hours.

In another embodiment, the password/token length may change depending upon the application or within the same application. For example, in one authentication system, the token could be 4 digits long and 8 digits long in the second authentication system. In other embodiments, the password may be stored in the same server as the token. In another embodiment, the token may be stored in an external server, to increase the security. In another embodiment, the authentication code may be sent via email. In another embodiment, the user device 102 may incorporate an online chat as a communication protocol. In other embodiments, the authentication methods described in this specification may be used to authenticate a user, a remote computer, and/or any other equipment. In another embodiment, the characters of the password may not be all in one location within the code containing the combination of the token and password, but there may be some characters of the token dispersed amongst the characters of the password.

### Method of Authentication

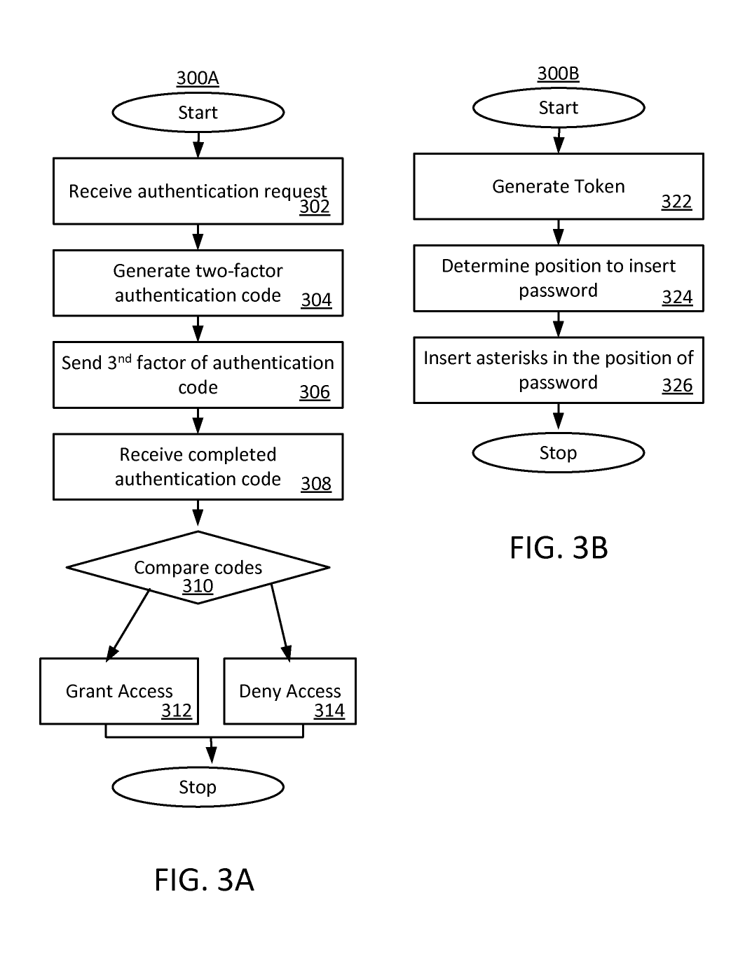

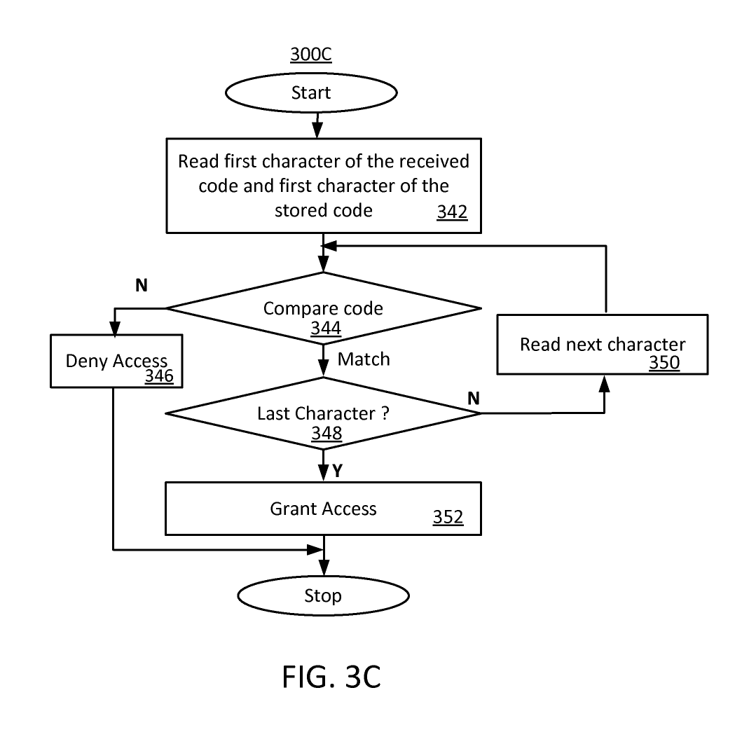

FIG. 3A shows a flowchart of an embodiment of method 300A authenticating user device 102 that is performed by authentication server system 106. In step 302, the authentication system 106 receives a request for authentication along with the registered phone number. In step 304, the authentication server system 106 may generate and store a two-factor authentication code. The first factor in the authentication code may be the password of the registered cellular phone number. The second factor may be a token generated by the authentication server system 106. The token may change with each transaction. The two-factors may be combined in various ways to authorize access. In step 306, the authentication code consisting of the second factor or token may be sent to user device 102, using SMS or email via network 104. In step 308, authentication server system 106 receives the completed code for authentication from secure system 101. In step 310, the stored authentication code of step 304 and the received code of step 308 are compared to determine whether the token in the received code is the same as the stored token, whether the password in the received code is the same as the stored password and whether the position of the password within the token is correct (the details of the token and password are discussed further in conjunction with FIG. 2). If the two codes match, method 300A proceeds to step 312 and in step 312, authentication server system 106 grants access to secure system 101. If the two codes do not match, method 300 proceeds to step 314 and in step 314, the authentication server system 106 denies access to secure system 101. The two-factor method described in method 300A may be secure, as the token may change for each transaction making phishing inefficient. The two-factor authentication method may be used in applications requiring a simple but strong authentication method.

In an embodiment, each of the steps of method 300A is a distinct step. In other embodiments, method 300A may not have all of the above steps and/or may have other steps in addition to or instead of those listed above. Subsets of the steps listed above as part of method 300A may be used to form their own method. In other embodiments, there could be multiple instances of method 300A.

FIG. 3B shows a flowchart of an embodiment of method 300B generating the two-factor authentication code by authentication server system 106. In step 322, the authentication server system 106 generates the token. The token may be unique to each transaction and may consist of any one or more than one or all of numerals, symbols and alphabets. In step 324, the position of the password is set based on the application. In an embodiment, the position of the password change with every transaction. In another embodiment, the position of the password is fixed. In step 326, one or more asterisks are inserted in the token in the position determined by step 324 to create the authentication code. In an embodiment, the number of asterisks may not be the same as the length of the password. In another embodiment, the number of asterisks can be equal to the length of the password.

In an embodiment, each of the steps of method 300B is a distinct step. In other embodiments, method 300B may not have all of the above steps and/or may have other steps in addition to or instead of those listed above. Subsets of the steps listed above as part of method 300B may be used to form their own method. In other embodiments, there could be multiple instances of method 300B.

FIG. 3C shows a flowchart of an embodiment of method 300C comparing the code received by the authenticating server system 106 (discussed in step 308)and the code stored in the authenticating server system 106 (discussed in step 304) to grant or deny access to secure system 101. In step 342, one character of the code received by authenticating server system 106 and one character in the code stored in the authenticating server system are compared and if the codes match, method 300C proceeds to step 348. If one character of the code received by authenticating server system 106 and one character in the code stored in the authenticating server system 106 do not match, method 300C proceeds to step 346. In step 346, the authenticating server system 106 denies access to secure system 101. In step 348, the stored code is checked if there are any more characters to compare. If the character compared is not the last character, method 300C proceeds to step 350.

If the character compared is the last character, method 300C proceeds to step 352. In step 350, the next character is received and the stored code is read. The loop comprising of comparing the characters in the code received and the code stored (step 344) and checking for last character (step 348) and reading next character (step 350) is repeated. In step 352, the authenticating server system 106 grants access to secure system 101. In the process of checking each character one at a time, the token, the password, and position of the password are checked, because if for example, the third character is supposed to be the first character of the password, and instead it is the next character of the token, the character will not match. Alternatively, the password and the location of the password may be extracted from the incoming code, and then the token, the password, and the position of the password (that were extracted) are each compared separately to the stored token, password, and position of the password.

In an embodiment, each of the steps of method 300C is a distinct step. In other embodiments, method 300C may not have all of the above steps and/or may have other steps in addition to or instead of those listed above. Subsets of the steps listed above as part of method 300C may be used to form their own method. In other embodiments, there could be multiple instances of method 300C.

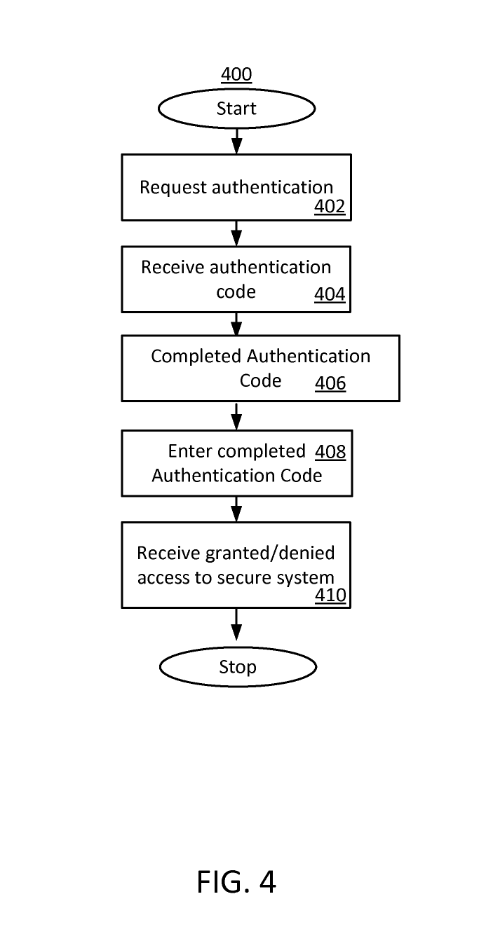

FIG. 4 shows a diagram of an embodiment of method 400 authenticating the user that is performed on user system. In step 402, a request for authentication to authentication server system 106 may be sent with the phone number of a registered user device. In step 404, the user device receives an authentication code. The authentication code may contain the token. The token may be a series of symbols that may be chosen from a predetermined set of symbols, such as digits, alphanumeric characters, and/or other symbols. Within the series of symbols another series of symbols are inserted, which are chosen from symbols that are not part of the predetermined set of symbols from which the symbols used for the token are chosen, which mark the position in which the user inserts a password. For example, the token may be a series of digits, and within the series of dummy characters, for example the dummy characters may be asterisks (e.g. ‘*’). The position of the dummy characters may mark the position of the user password. In an embodiment, the dummy characters may indicate the start of the user password. In another embodiment, the position of the dummy characters may indicate the position of the password. In another embodiment, the number of dummy characters may not indicate the number of characters in the password. In step 406, the user system completes the password by replacing the asterisks with the password registered with the authentication server system 106. In step 408, the completed authentication code may be sent to the authentication server system 106 for access to secure system 101. The completed authentication code may be sent to the authentication server system 106 directly, to secure system 101, or a merchant system via secure system 101, using network 104. In step 410, user system may be granted or denied access to secure system 101. Step 410 may also include informing secure system 101 to grant access to user system. In an embodiment, each of the steps of method 400 is a distinct step. In other embodiments, method 400 may not have all of the above steps and/or may have other steps in addition to or instead of those listed above. Subsets of the steps listed above as part of method 400 may be used to form their own method. In other embodiments, there could be multiple instances of method 400.

### Two Step-Method for Mobile Device Based Authentication

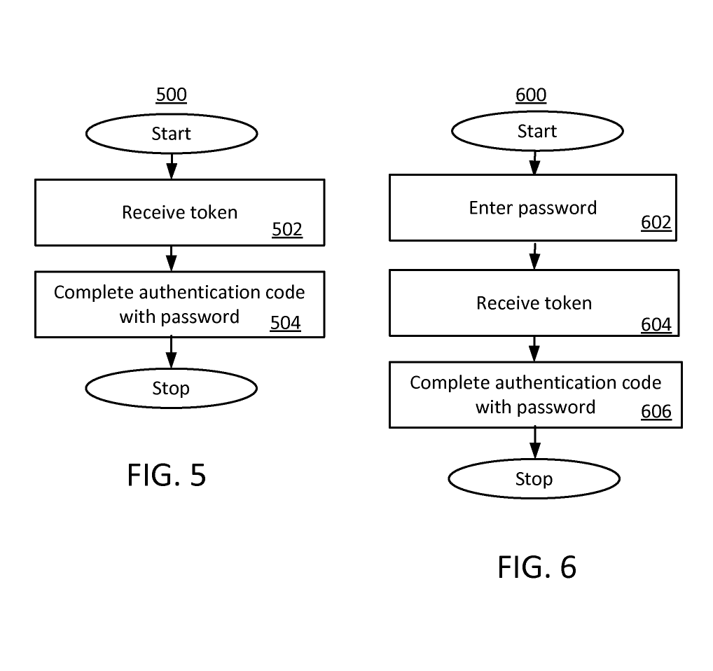

FIG. 5 shows a flowchart of an embodiment of method 500, a two-step method of authentication using mobile devices. In step 502, registered user device 102 receives the authentication code consisting of a token (discussed in conjunction with FIG. 4) in response to a request for authentication code. The authentication code may contain the token and asterisks in a location for placing a password within a string of symbols that form the token. In step 504, authentication code may be completed by replacing the asterisks with symbols that make up the password.

In an embodiment, each of the steps of method 500 is a distinct step. In other embodiments, method 500 may not have all of the above steps and/or may have other steps in addition to or instead of those listed above. Subsets of the steps listed above as part of method 500 may be used to form their own method. In other embodiments, there could be multiple instances of method 500.

FIG. 6 shows a flowchart of an embodiment of method 600, a three-step method of authentication using mobile devices. In step 602, registered user device 102 submits a password requesting an authentication code. In step 604, user device 102 receives the authentication code (discussed in conjunction with FIG. 4) in response to a request for authentication code. The authentication code may consist of a token and asterisks. In step 604, authentication code may be completed by replacing the asterisks with a password.

In an embodiment, each of the steps of method 600 is a distinct step. In other embodiments, method 600 may not have all of the above steps and/or may have other steps in addition to or instead of those listed above. Subsets of the steps listed above as part of method 600 may be used to form their own method. In other embodiments, there could be multiple instances of method 600.

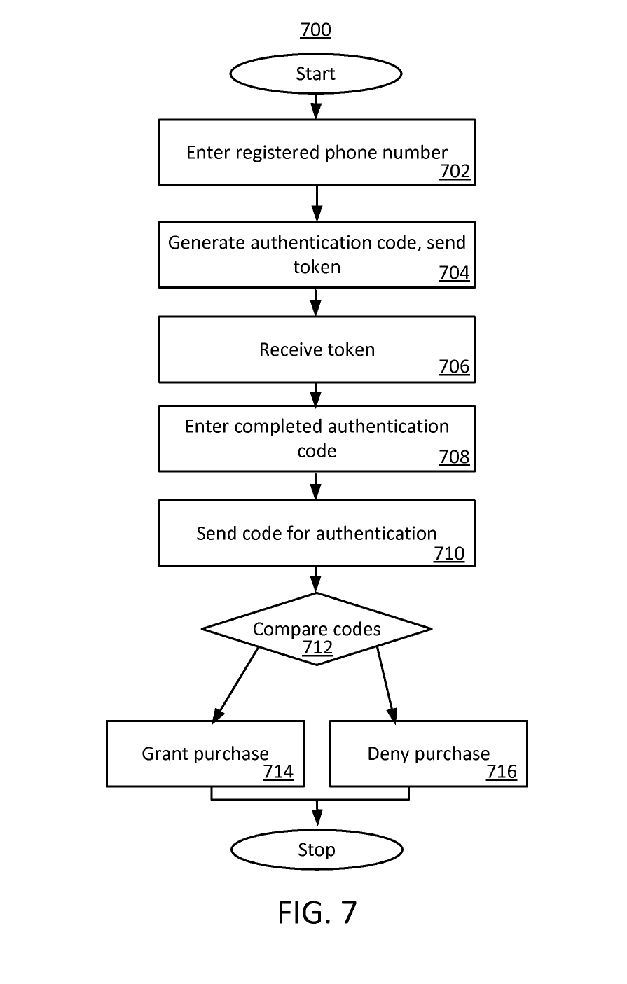

FIG. 7 shows a flowchart of method 700 in an embodiment for online purchasing with a credit card using two-factor authentication method. In step 702, the registered phone number of user device 102 may be entered to purchase. In step 702, the authentication server system generates a two-factor authentication code consisting of a token and the user password, and stores the two factor code (discussed in conjunction with FIG. 2). In an embodiment, authentication server system 106 sends the token part of the authentication code to user device 102 using SMS, email, or any other protocol. In step 706, user device 102 receives the token. In step 708, the user enters the authentication code, replacing the asterisks in the token with the user password at the purchasing system. In step 708, the purchasing system sends the authentication code entered by the user to the authentication server system 106 for authentication. In step 712, the authentication server system 106 checks the user entered authentication code for numbers of the token, the position of the password, and the password and compares with the stored two-factor code. If the user entered authentication code matches with the stored two-factor code, method 700 proceeds to step 714, and in step 714 the authentication server system 106 informs the purchasing system to grant the purchase. If the user entered authentication code does not match with the stored two-factor code, method 700 proceeds to step 716 and in step 716, the authentication server system 106 informs the purchasing system that the codes do not match and denies purchase.

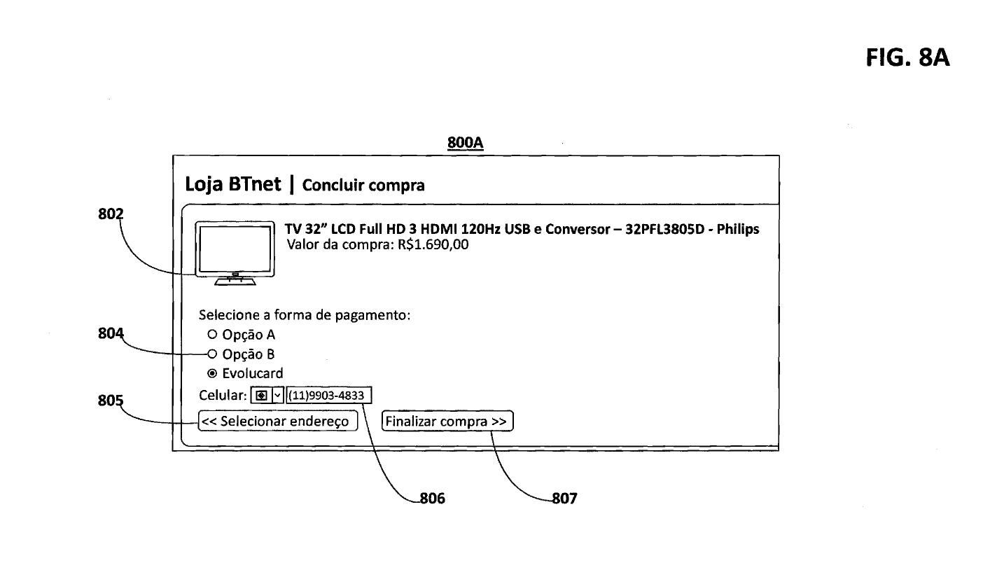

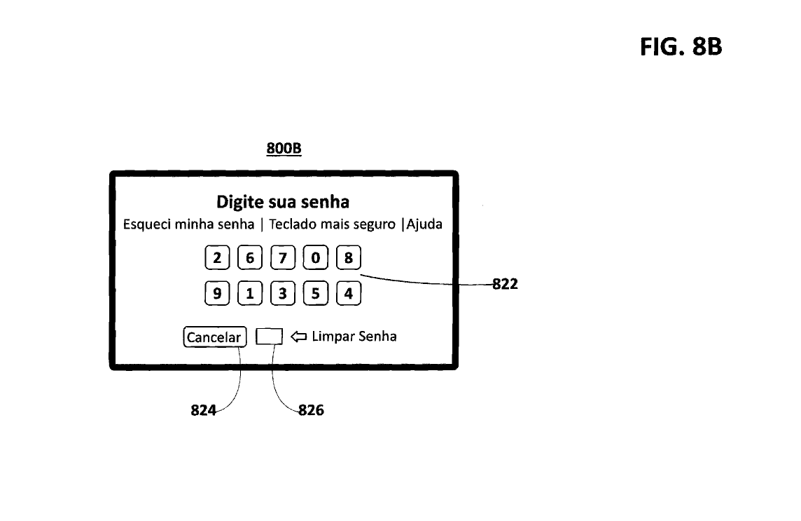

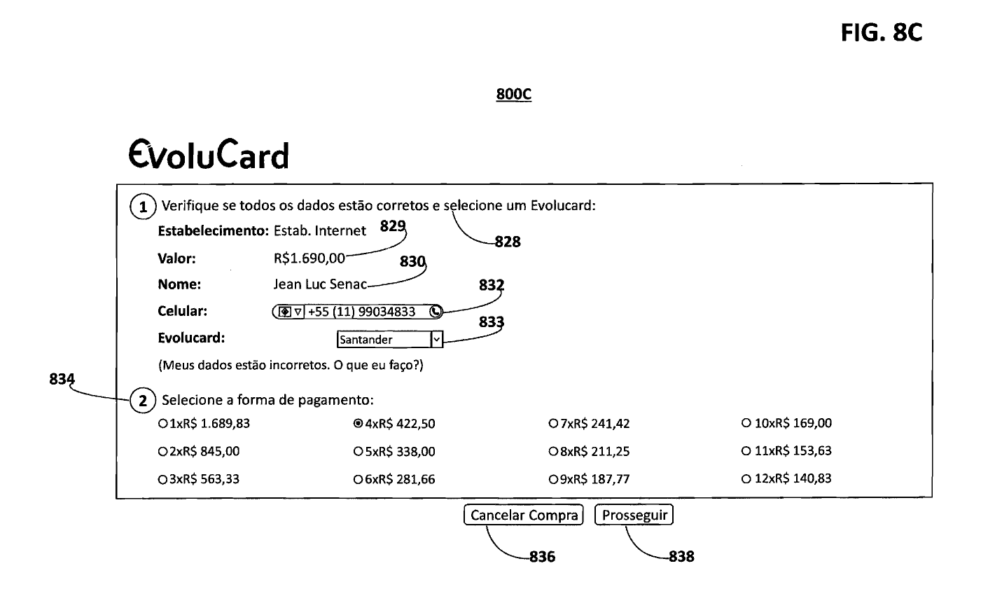

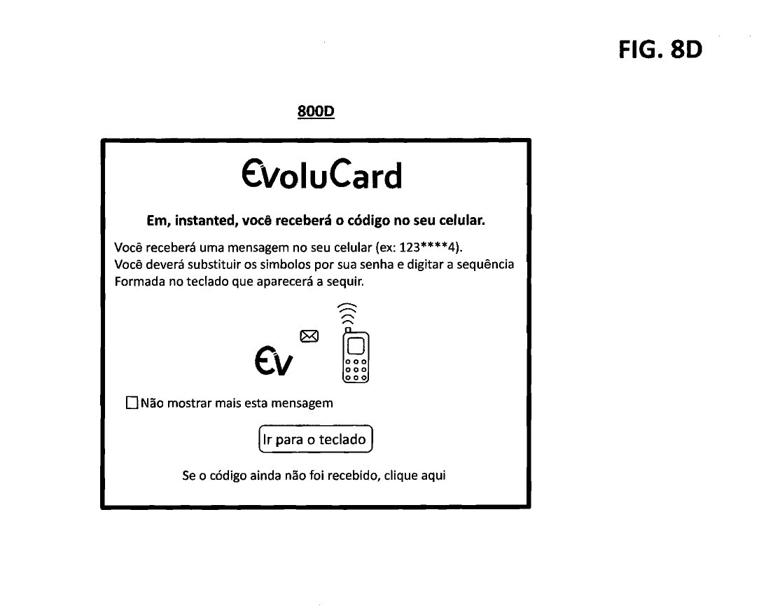

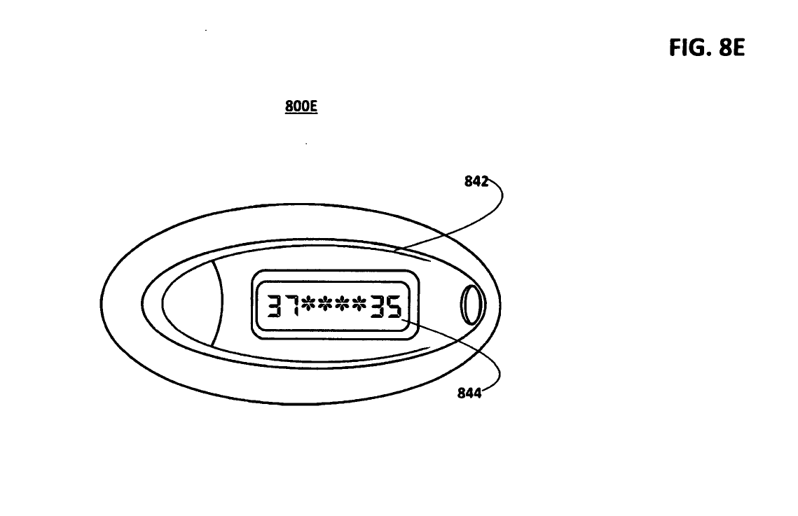

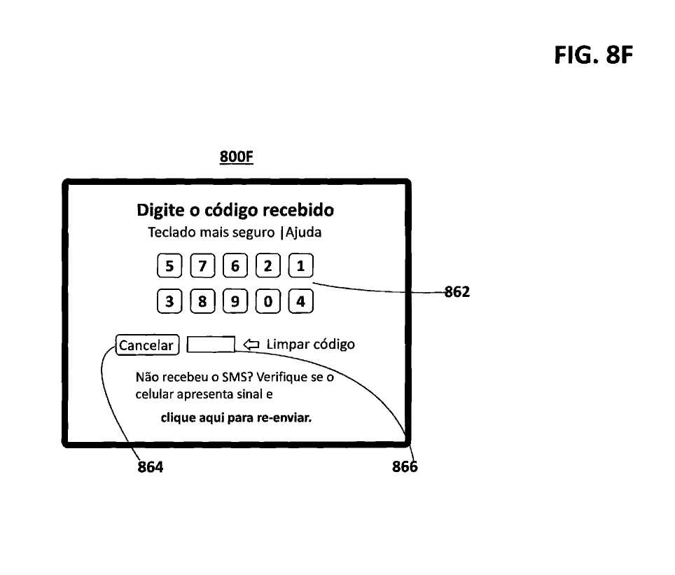

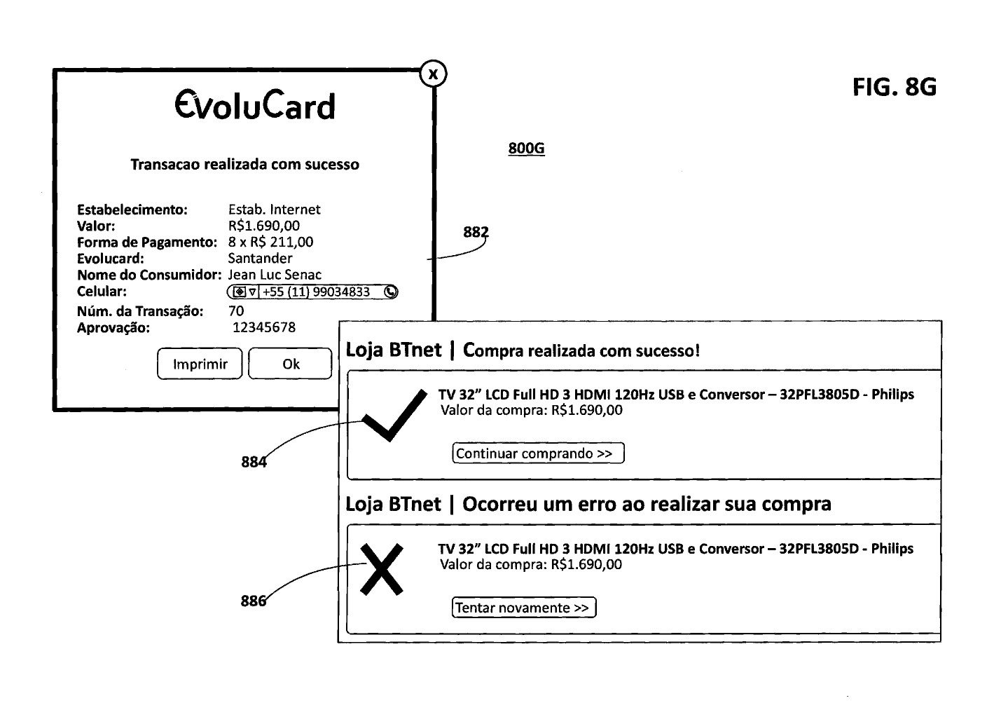

FIGS. 8A-8G shows an embodiment of a method that allows interne purchasing with a credit card using the authentication method discussed in conjunction with FIG. 7.

FIG. 8A shows screenshot 800A of a web page in an embodiment requesting an authentication code by entering a mobile phone number as discussed in step 702. FIG. 8A has product 802, payment method 804, select 805, phone number 806 and finalize 807. In other embodiments screenshot 800A may not have all of the elements or features listed and/or may have other elements or features instead of or in addition to those listed.

Product 802 may be a product that is being purchased which may be displayed on a webpage. Payment method 804 lists the methods of payment for purchasing product 802. Screenshot 800A shows the selection of a payment method ‘Evolucard.’ Select 805, when selected, returns to another screen to select the product. Phone number 806, may be a registered phone number for payment, for example a Brazilian phone number. Finalize 807, when selected, finalizes the purchase.

FIG. 8B shows screenshot 800B of an embodiment of a web page for entering a password. FIG. 8B has keypad 822, cancel button 824, and clear button 826. In other embodiments screenshot 800B may not have all of the elements or features listed and/or may have other elements or features instead of or in addition to those listed.

Keypad 822 may be a keypad for entering a password. In the embodiment of FIG. 8B, keypad 822 is for entering numbers and the password is composed of numbers. In an another embodiment the password may be composed of letters, numbers, or symbols and may be of any length and keypad 822 may include keys for other symbols. Cancel button 824 cancels the step of entering the password and clear button 826 clears the entered password.

FIG. 8C shows screenshot 800C of an embodiment of a web page for choosing the account and method of payment. FIG. 8C has verify 828, value 829, name 830, phone number 832, card 833, payment method 834, cancel button 836, and continue button 838. In other embodiments, screenshot 800C may not have all of the elements or features listed and/or may have other elements or features instead of or in addition to those listed.

Screenshot 800C is a screenshot of a webpage listing the purchasing information so that the user can verify that the purchase they are making is what the item desired. Verify 828 suggests the user to verify the data on the screen. Value 829 displays the value of the purchasing item. Name 820 displays the name of the purchaser. Phone number 832 may be the phone number of the registered user device 102. Card 833 displays the selected card for payment. Payment method 834 lists one or more payment methods available and shows the chosen payment method. Cancel button 836 when selected cancels the transaction and continue button 838. when selected, proceeds to the next step in the purchasing process. The method of payment might be a credit card, checking account, or any other financial account.

FIG. 8D shows in an embodiment of screenshot 800D of a webpage where the purchasing system contacts the bank for authorization. The purchasing system receives user inputs i.e. the registered phone number (discussed in conjunction with FIG. 8A) and the password (discussed in conjunction with FIG. 8B) and contacts secure system 101 to authorize payment for purchase. Secure system 101 may be a bank. The bank contacts the authentication server system 106 to issue an authentication code. The authentication code may be sent via SMS or any other protocol.

FIG. 8E shows an embodiment of a user device displaying the token or part of the authentication code. FIG. 8E has user device 842 and message 844. In other embodiments FIG. 8E may not have all of the elements or features listed and/or may have other elements or features instead of or in addition to those listed.

User device 842 may be user device 102 that may be registered with authentication server system 106. Message 844 may be an SMS received from the authentication server system with the token or part of the authentication code. FIG. 8E shows a display of the authentication code and one or more asterisks that need to be replaced with the user password.

FIG. 8F shows an embodiment of screenshot 800F of a keypad for entering the authentication code. FIG. 8F has keypad 862, cancel button 864, and clear code button 866. In other embodiments, screenshot 800F may not have all of the elements or features listed and/or may have other elements or features instead of or in addition to those listed.

Keypad 862 may be a virtual keypad for entering the authentication code. The authentication code may be completed by replacing the asterisks in the token with the user password. In other embodiments, the keypad may be in any other form. Cancel button 864, when selected, cancels the entering process. Clear code button 866, when selected, clears the entered code.

FIG. 8G shows an embodiment of screenshot 800G after checking for the authentication code. FIG. 8G has successful transaction 882, purchase successful 884, and purchase unsuccessful 886. In other embodiments, screenshot 800G may not have all of the elements or features listed and/or may have other elements or features instead of or in addition to those listed.

Successful transaction 882 may be a message from secure system 101 showing a successful transaction with the matching of the authentication code. Purchase successful 884 may be a message from the purchasing system displaying the result after a successful transaction from the secure system or the bank. Purchase unsuccessful 886 may be a message from the purchasing system when the bank cannot confirm a transaction due to the authentication codes not matching.

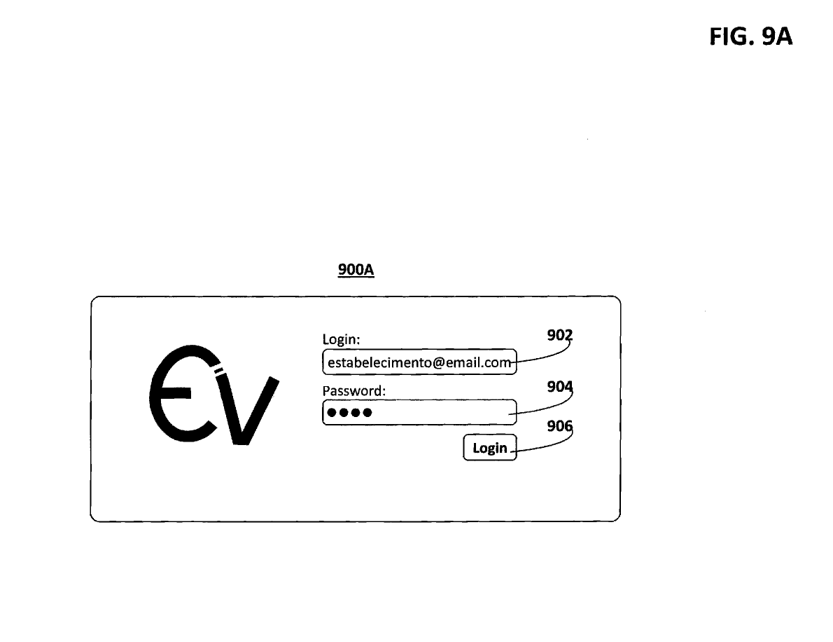

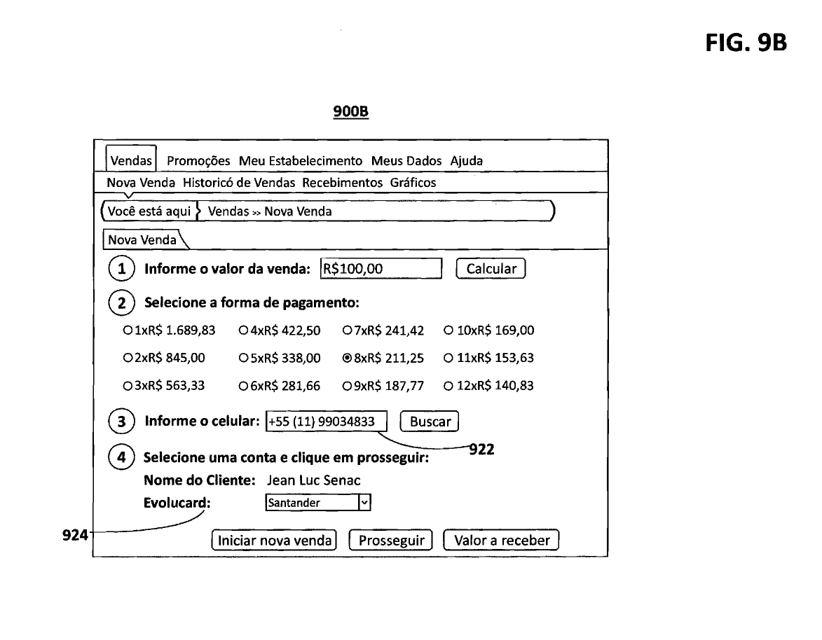

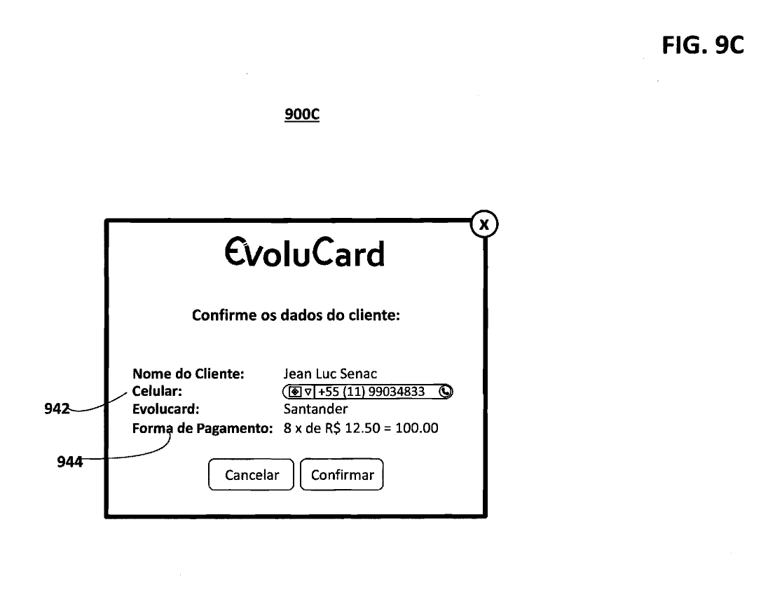

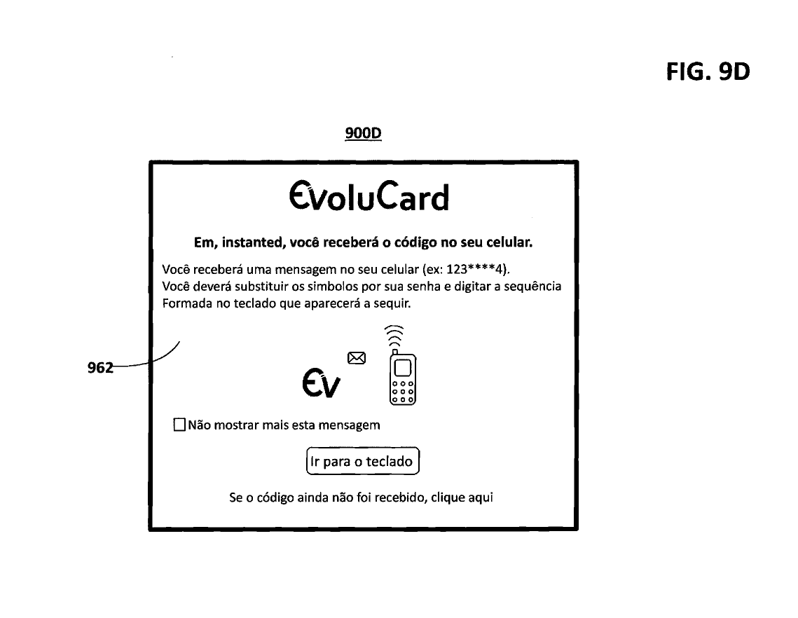

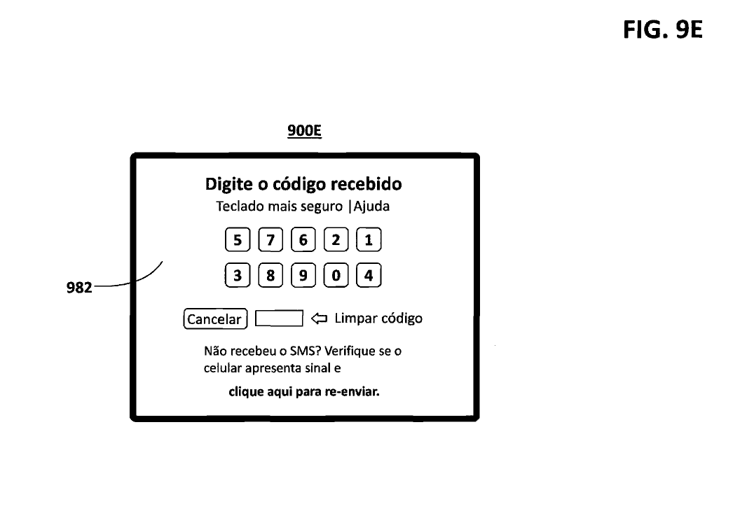

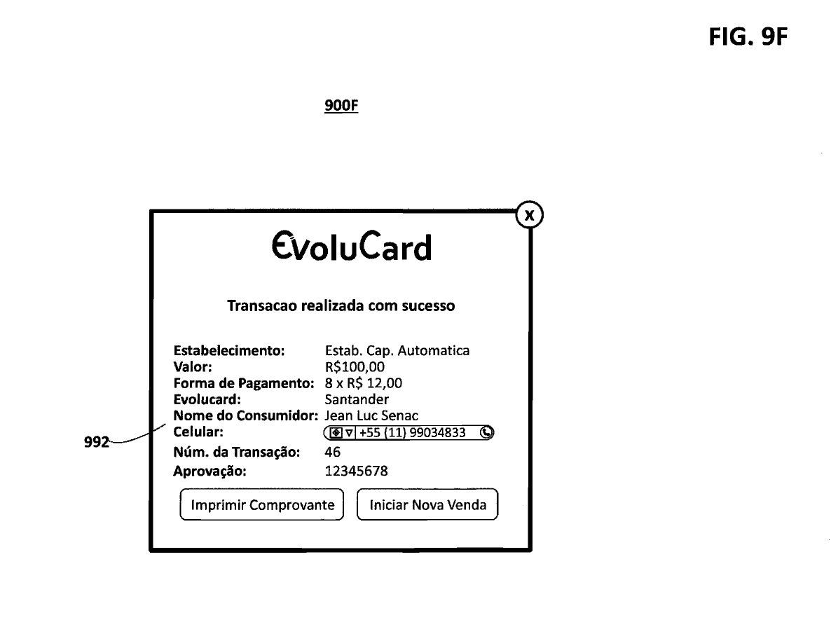

FIGS. 9A-9F show an embodiment of an application that allows a merchant to sell by phone or in a business location with a credit card using an email address and password. In FIGS. 9A-9F, a secure system may refer to a bank. Secure system may be secure system 101 and authentication system may be authentication server system 106. In an embodiment, the secure system and the authentication system may reside in a single system or on different systems.

FIG. 9A shows screenshot 900A in an embodiment of a purchasing system entering the email address and password of the merchant. Screenshot 900A has email address 902, password 904, and login button 906. In other embodiments screenshot 900A may not have all of the elements or features listed and/or may have other elements or features instead of or in addition to those listed.

Email address 902 may be the email address of the merchant registered with the authentication server system. Password 904 may be the password associated with registered email address 902. Login button 906, when selected, validates the merchant's login i.e. email address and password. In other embodiments, this login process might include other fields to be used to verify the merchant identity.

FIG. 9B shows screenshot 900B in an embodiment of a purchasing system entering a phone number. Screenshot 900B has phone number 922 and payment method 924. In other embodiments, screenshot 900B may not have all of the elements or features listed and/or may have other elements or features instead of or in addition to those listed.

In an embodiment, the merchant enters information regarding a customer purchase, including the total value of the purchase, the payment method chosen by the customer, customer mobile phone number and customer account if the customer has multiple accounts. Phone number 922 may be the phone number registered or associated with a bank or an authentication system for purchase. Payment 924 may be the payment method for purchase.

FIG. 9C shows screenshot 900C in an embodiment of a purchasing system confirming the customer's information. Screenshot 900C has customer information 942 and payment method 944. In other embodiments, screenshot 900C may not have all of the elements or features listed and/or may have other elements or features instead of or in addition to those listed.

Screenshot 900C may be an optional step in the process for processing merchant information that is related to a purchase. Customer information 942 lists the details of the customer including the name and the phone number associated with the payment for purchase. Payment 944 lists the payment details, including payment method and bank name.

FIG. 9D shows screenshot 900D in an embodiment of a purchasing system confirming the customer's information. Screenshot 900D has message 962. In other embodiments, screenshot 900D may not have all of the elements or features listed and/or may have other elements or features instead of or in addition to those listed.

In an embodiment, if the bank authorizes the payment, authentication system 106 sends an SMS to the customer containing a password with asterisks. Message 962 may be a message from the bank in response to submitting the phone number to the bank or the authentication server system by the merchant for authentication for the payment. Message 962 may be the message from the bank informing about a token dispatched via SMS.

FIG. 9E shows screenshot 900E in an embodiment of a secure system or bank requesting the authentication code. Screenshot 900E has keypad 982. In other embodiments screenshot 900E may not have all of the elements or features listed and/or may have other elements or features instead of or in addition to those listed.

Screenshot 900E shows a screenshot of a webpage with a message from secure system 101 requesting the user to enter the authentication code. The authentication code may be generated by replacing the asterisks in the token received via SMS with the user password. In an embodiment, the data entry may be accomplished by using a virtual keyboard. In other embodiments, any input method may be used.

FIG. 9F shows screenshot 900F in an embodiment of a secure system 101 or bank displaying a successful authentication code. Screenshot 900F has purchase information 992. In other embodiments screenshot 900F may not have all of the elements or features listed and/or may have other elements or features instead of or in addition to those listed.

The secure system after receiving the authentication code sends the code to the authentication system 106 for authentication. The authentication system compares the received code to the stored code and sends the result of the comparison to the secure system. If the code is authenticated by the authentication server system, the secure system completes the transaction and informs the merchant system of the successful result. Purchase information 992 may be a display of the successful transaction by the secure system.

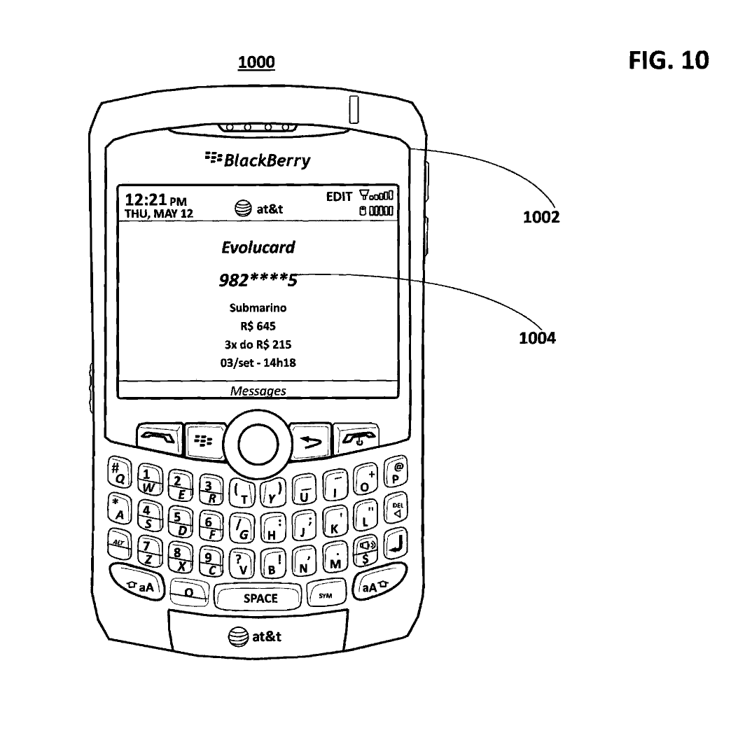

FIG. 10 shows screenshot 1000, an embodiment of a user generated code. Screenshot 1000 has user device 1002 and code 1004. In other embodiments screenshot 1000 may not have all of the elements or features listed and/or may have other elements or features instead of or in addition to those listed.

User device 1002 may be any device such as a mobile phone, PDA, iPad or other mobile devices. In an embodiment, user device 1002 with a pseudo random sequence in its hardware or software may generate a code. In an embodiment, user device 1002 may be synchronized with an authentication server system 106 based on time or signals received at intervals. Code 1004 may be the token generated by user device 1002. Code 1004 may be used instead of the authentication server system sending the token.

FIG. 11 shows a block diagram of console 1100. Console 1100 may be user device 102. User device 102 may include output system 1102, input system 1104, memory system 1106, processor system 1108, communications system 1112, and input/output device 1110.

Console 1100 is an example of a communication device that may be used for implementing the authentication. Console 1100 may be a mobile internet appliance, such as a mobile phone, notepad, laptop, or another internet appliance. In other embodiments, console 1100 may be an internet appliance that is not mobile. The server that serves the webpage having the virtual keyboard may also be represented by a device similar to console 1100.

Output system 1102 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example. Output system 1102 may include an antenna (e.g., if console 1100 is a mobile device) and/or a transmitter (e.g., if console 1100 is a mobile device).

Input system 1104 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g. IrDA, USB). Input system 1104 may include an antenna (e.g., if console 1100 is a mobile device) and/or a receiver (e.g., if console 1100 is a mobile device).

Memory system 1106 may include, for example, any one of, some of, any combination of, or all of a long term storage system, such as a hard drive; a short term storage system, such as random access memory; a removable storage system, such as a floppy drive or a removable drive; and/or flash memory. Memory system 1106 may include one or more machine readable mediums that may store a variety of different types of information. The term machine-readable medium is used to refer to any medium capable carrying information that is readable by a machine. One example of a machine-readable medium is a computer-readable medium. Another example of a machine-readable medium is paper having holes that are detected that trigger different mechanical, electrical, and/or logic responses. In memory system 1106 is the authentication server, memory system 1106 may store authentication codes, passwords, and/or tokens that were generated, code for generating the tokens, and code for carrying out the methods of FIGS. 1-10.

Processor system 1108 may include any one of, some of, any combination of, or all of multiple parallel processors, a single processor, a system of processors having one or more central processors and/or one or more specialized processors dedicated to specific tasks. Also, processor system 1108 may include one or more Digital Signal Processors (DSPs) in addition to or in place of one or more Central Processing Units (CPUs) and/or may have one or more digital signal processing programs that run on one or more CPU.

Input/output system 1110 may include devices that have the dual function as input and output devices. For example, input/output system 1110 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 1110 is optional, and may be used in addition to or in place of output system 1102 and/or input device 1104.

Communications system 1112 communicatively links output system 1102, input system 1104, memory system 1106, processor system 1108, and/or input/output system 1110 to each other. Communications system 1112 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

### EXTENSIONS AND ALTERNATIVES

In an embodiment the asterisk in the token may be replaced by any character or sign. In another embodiment, the number of asterisks may not have relationship with the length of the password. Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method of providing access to a secure system, via an authentication server system, comprising:
sending, by a host system including at least one more machines having a processor system with one or more processors and a memory system having one or more machine readable media, to a user system, a token, a string of one or more dummy characters, and a position within the token for placing the string of one or more dummy characters, and client-machine instructions, which when implemented by the user system cause the user system to display the token with the string of dummy characters inserted within the token in at the position within the token;
receiving, by the host system, the authentication code including the token and the password in the location;
comparing, by the host system, the code received to the code stored in the memory system; and
if, the code received matches the code stored, sending a message, by the host system, to grant access to a secure system.

2. The method of claim 1, the host system including an authentication server system, the method further comprising:
prior to the sending, receiving a request for the authentication code along with a phone number of a user device by the authentication server system, the request including the phone number of the user device and a password registered with the authentication server system;
generating an authentication code including at least the token and the password of the user device; and
storing the authentication code in the memory system.

3. The method of claim 1, the receiving of request for authentication code being via Short Messaging System (SMS).

4. The method of claim 1, the position of the password in the authentication code is any position in the authentication code.

5. The method of claim 1, the token includes at least one or more letters, symbols and signs.

6. The method of claim 1, the authentication code is valid for a predetermined fixed number of times of use.

7. The method of claim 1, the authentication code being valid up to a predetermined fixed period of time.

8. The method of claim 1, the string of one or more dummy characters includes at least one or more asterisks as dummy characters.

9. The method of claim 1, the comparing includes comparing the token, the password and the position of the password.

10. The method of claim 1, the receiving of the authentication code occurs via email.

11. The method of claim 1, the memory system is located remotely from the system.

12. The method of claim 1, the user system is a device with a display screen that is dedicated to displaying the token, and the sending of the token, the string of one or more dummy characters, the position within the token for placing the string of one or more dummy characters, and the client-machine instructions, includes sending instructions which when implemented by the dedicated device cause the user system to display the token with the string of dummy characters inserted within the token at the position within the token on the display of the dedicated device.

13. The method of claim 1,
the receiving of request for authentication code being via Short Messaging System (SMS);
the receiving of request for authentication code being via internet;
the receiving of request for authentication code being via phone;
the position of the password in the authentication code is any position in the authentication code;
the token includes at least one or more letters, symbols and signs;
the authentication code is valid for a predetermined fixed number of times of use;
the authentication code being valid up to a predetermined fixed period of time;
the string of one or more dummy characters has one or more asterisks;
the comparing includes comparing the token, the password and the position of the password;
the receiving of the authentication code is via Short Messaging System (SMS);
the memory system is located in the authentication server system.

14. A machine readable medium containing at least one or more sequences of instructions, for implementing a method for providing access to a secure system, the method comprising:
sending, by a host system including at least one more machines having a processor system with one or more processors and a memory system having one or more machine readable media, to a user system, a token, a string of one or more dummy characters, and a position within the token for placing the string of one or more dummy characters, and client-machine instructions, which when implemented by the user system cause the user system to display the token with the string of dummy characters inserted within the token in at the position within the token;
receiving, by the host system, the authentication code including the token and the password in the location;
comparing, by the host system, the code received to the code stored in the memory system; and
if, the code received matches the code stored, sending a message, by the host system, to grant access to a secure system.

15. A system with one or more machines, the machine comprising:
a processor system including one or more processors;
a storage system having one or more machine readable media, storing thereon one or more instructions for implementing an application that includes one or more instructions that cause the processor system to perform a method including at least:
sending, by a host system including at least one more machines having a processor system with one or more processors and a memory system having one or more machine readable media, to a user system, a token, a string of one or more dummy characters, and a position within the token for placing the string of one or more dummy characters, and client-machine instructions, which when implemented by the user system cause the user system to display the token with the string of dummy characters inserted within the token in at the position within the token;
receiving, by the host system, the authentication code including the token and the password in the location;
comparing, by the host system, the code received to the code stored in the memory system; and
if, the code received matches the code stored, sending a message, by the host system, to grant access to a secure system.
